(19) United States
(12) Patent Application Publication
(10) Pub. No.: US 2009/0096628 A1
(43) Pub. Date: Apr. 16, 2009

(54) Purchasing System and Method

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 12/210,626

(22) Filed: Sep. 15, 2008

Related U.S. Application Data
(60) Provisional application No. 60/972,280, filed on Sep. 14, 2007.

(51) Int. Cl. G08B 5/38; G08B 5/36

(52) U.S. Cl. 340/691.6

(57) ABSTRACT

Described herein is a system and method for purchasing a particular item located within a store. The system includes an interface device having an input device, and an indicator apparatus having at least one indicator, an indicator corresponding to each item in a collection of items in the store. The system further includes a communication apparatus for communication between the interface device and the indicator apparatus. The input device accepts data associated with the particular item and causes the indicator corresponding thereto to emit a signal indicative of the location of the particular item.

### CROSS REFERENCE TO RELATED APPLICATION

This application claims priority to U.S. provisional application No. 60/972,280, filed on Sep. 14, 2007.

### BACKGROUND OF INVENTION

“Big-box stores” displaying merchandise on a large floor space have become commonplace. A customer walking into such a store often feels bewildered at the amount of merchandise spread out over large areas. Finding a particular item in such a large store is often difficult. Signs overhead are often confusing, and finding an available employee to ask for assistance is time consuming. Any invention that improves the shopping experience at such stores would be welcome.

### SUMMARY OF INVENTION

Described herein is a system and method for purchasing a particular item located within a store that improves the current shopping experience. The system includes an interface device having an input device, such as a computer kiosk, which can be accessed by a customer at a convenient location, such as near or in the store.

The system further includes an indicator apparatus having at least one indicator, one or more indicators corresponding to each item in a collection of items in the store. For example, the indicator can be a set of lights.

A communication apparatus allows communication between the interface device and the indicator apparatus. The input device accepts data associated with the particular item and causes the one or more indicators corresponding thereto to emit a signal indicative of the location of the particular item.

### BRIEF DESCRIPTION OF THE ILLUSTRATED EMBODIMENTS

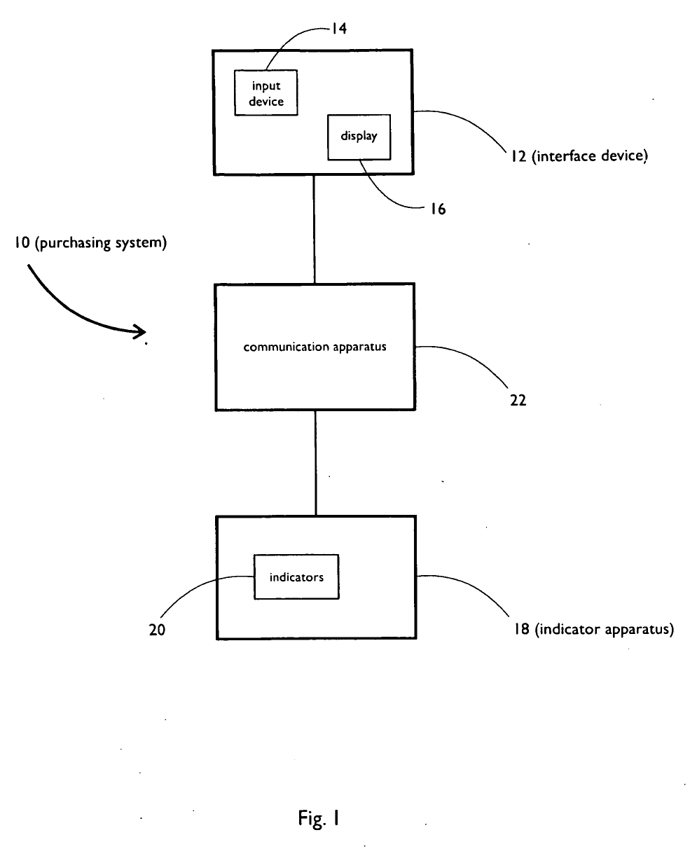

FIG. 1 is a block diagram of a purchasing system in accordance with the principles of the present invention.

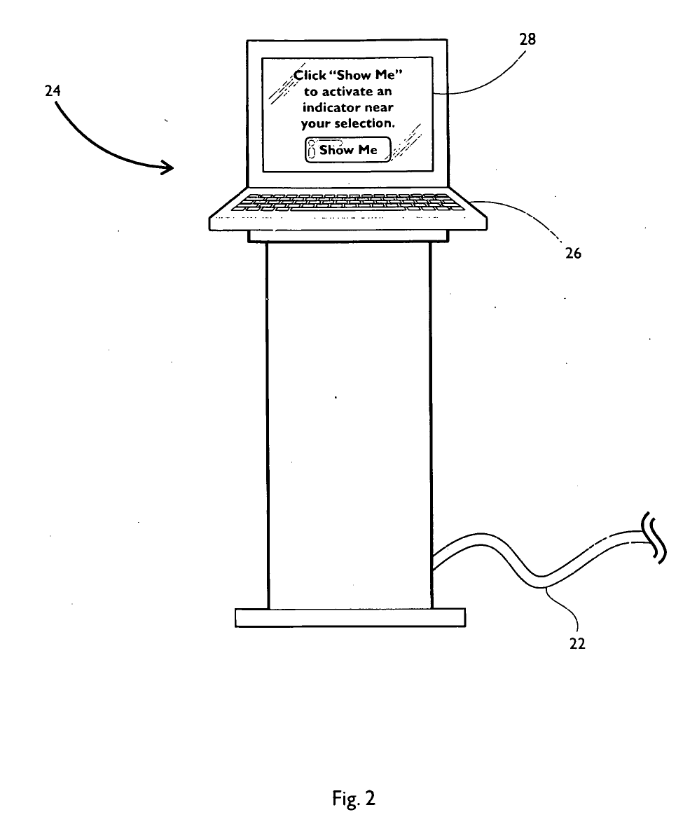

FIG. 2 depicts a computer kiosk that can be included in the interface device of FIG. 1.

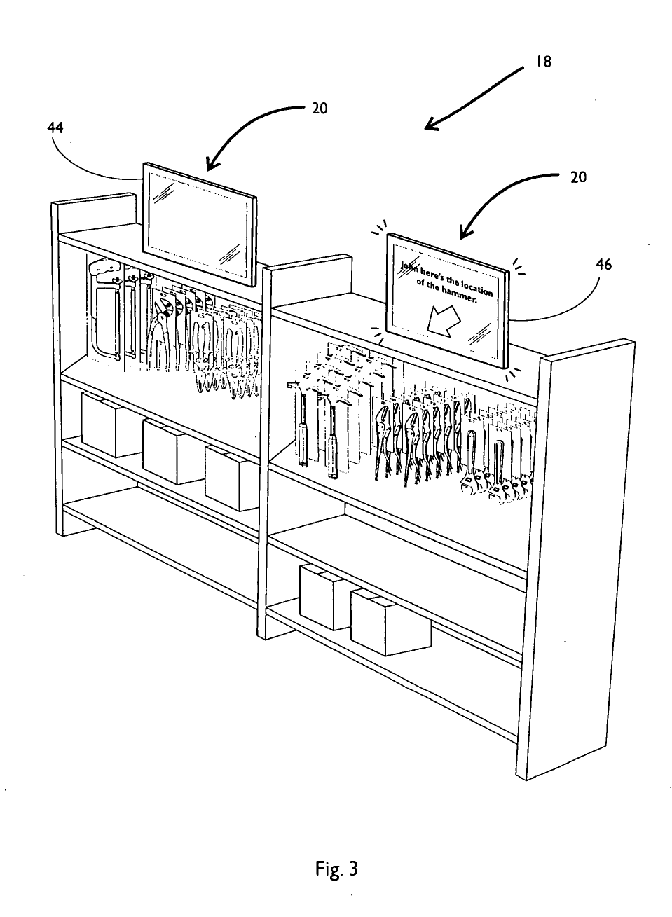

FIG. 3 depicts one embodiment of the indicator apparatus of FIG. 1.

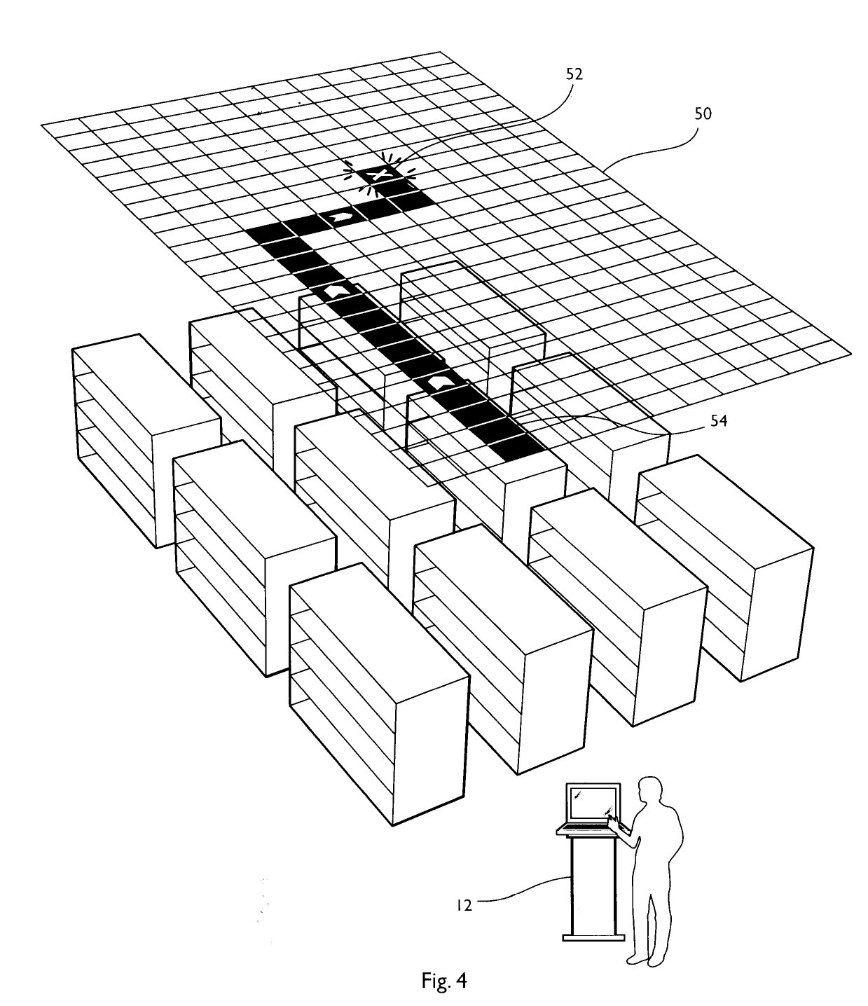

FIG. 4 depicts part of an indicator apparatus of FIG. 1 that includes a network of lights or displays suspended from the ceiling of a store.

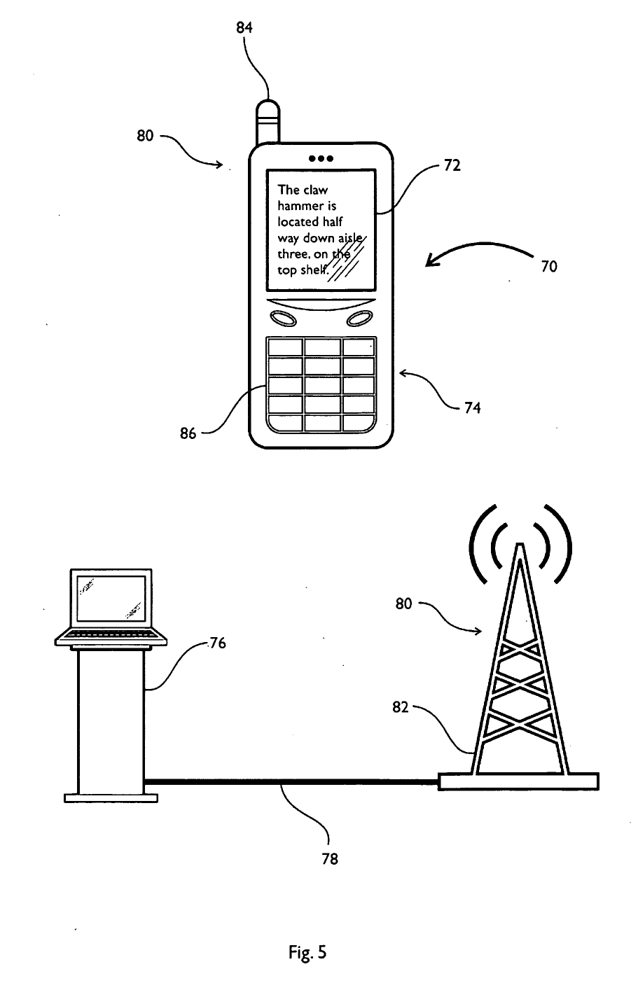

FIG. 5 depicts an indicator apparatus of FIG. 1 that includes a display of a cell phone.

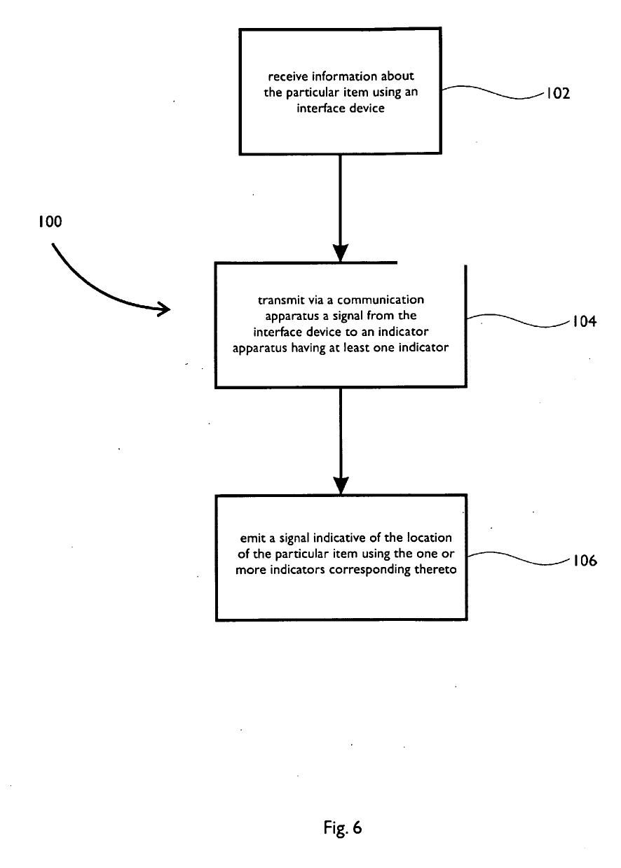

FIG. 6 is a flow chart of a method for purchasing a particular item located within a store in accordance with the principles of the present invention.

### DETAILED DESCRIPTION

FIG. 1 shows a block diagram of a purchasing system 10 in accordance with the principles of the present invention. The purchasing system 10 includes an interface device 12, which can be a kiosk, a personal computer, or a cell phone, for example. The interface device 12 includes an input device 14, such as a keyboard or keypad, and can also include a display 16. The purchasing system 10 also includes an indicator apparatus 18, which can be located in a store in which a user wishes to purchase a particular item. The indicator apparatus 18 includes a plurality of indicators 20, such that to each item in a collection of items in the store there correspond one or more indicators.

If there are N items in the collection, the indicator apparatus may include M indicators, where N is equal to M, greater than M or less than M. An example where M is equal to one occurs in an embodiment described in more detail below where the indicator apparatus includes one display in a cell phone. The one display can be used to locate several items, as explained below.

A communication apparatus 22 allows the interface device 12 to be in communication with the indicator apparatus 18. The communication apparatus 22 can depend on a physical connection between the interface device 12 and the indicator apparatus 18, or can depend on wireless communication, or a combination thereof.

In operation, a user enters information using the interface device 12. The user can enter information via a keyboard or keypad and can optionally view information on the display 16 of the interface device 12. The user inputs information that allows the identification of the particular item that the user wishes to purchase from the store. After the user enters commands associated with the particular item, the interface device 12 sends activation signals to the indicator apparatus 18 via the communication apparatus 22. These signals cause the indicator corresponding to the particular item to be activated. The corresponding indicator may be proximal to the particular item and produces a detectable signal that is indicative of the location of the particular item within the store.

Several types of interface devices 12 are contemplated by the inventor. For example, FIG. 2 shows a computer kiosk 24 that can be used as the interface device 12 of FIG. 1. The computer kiosk 24 includes an input device 14, in the form of a keyboard 26, and a kiosk display 28. The user can enter information into the kiosk 24 using the keyboard 26. Such information, supplied in response to prompts, includes the type of item to be purchased. Thus, the kiosk display 28 might query the user, “Type in the item you wish to purchase.” In response, the user might type “hammer” using the keyboard. The computer kiosk 24 might then prompt the user to select one of a claw hammer, mallet or a jack hammer. After the user makes his selection, the computer kiosk 24 might provide the location of the selection: “The claw hammer is in aisle 4 at the back of the store. Click ‘show me’ to activate an indicator near your selection.” After the user clicks the “show me” tab, a signal is carried by the communication apparatus 22 that causes an indicator to be activated for a certain period of time. The activated indicator is indicative of the location of the claw hammer, as described in more detail below.

In yet another embodiment, the interface device 12 can include a cell phone having an input device, such as a keypad, and a display. A purchaser calls a telephone number and is prompted to enter data that identifies the item to be purchased. The communication apparatus 22 in this embodiment includes a telephone relay station. The cell phone sends an activation signal to the telephone relay station. Upon receipt of the signal, the telephone relay station sends other activation signals, through a physical connection or wirelessly, to a communication network that also forms part of the communication apparatus 22. The communication network is in communication with an indicator apparatus in the store. As mentioned above, various embodiments of the indicator apparatus are possible.

In one embodiment, a signal indicative of the location of particular item can be shown on the display of the cell phone. For example, a message can appear on the display of the phone to help locate the item. In these embodiments, the cell phone is part of the interface device and the indicator apparatus.

FIG. 3 shows one embodiment of the indicator apparatus 18 of FIG. 1. The indicator apparatus 18 has a plurality of indicators 20 that includes indicator displays 44 and 46, which are in communication with the interface device 12 (not shown in FIG. 3) via the communication apparatus 22 (not shown in FIG. 3). The display 46 is above the particular item, which for illustrative purposes is a hammer, which the user wishes to purchase. On the indicator display, a sign, such as an arrow and the purchaser's name, which the purchaser entered using the interface device, is flashing. Specifically, the display reads “John, here's the location of the hammer.”

In one embodiment, the user or purchaser enters a store and approaches the interface device 12, such as a computer kiosk. As described above, the user enters into the computer kiosk his name and some data associated with the hammer. For example, the user could type in the word “hammer.” On the kiosk display, several types of hammers may be illustrated. The user can choose a particular hammer. The user may then issue a command using the computer kiosk to indicate that the user wishes to go to the location in the store where the particular hammer is located. In response, the computer kiosk sends a signal, via the communication apparatus, that causes the indicator display to flash the user's name. When the user approaches the general area where hammers are located, he notices his flashing name and knows that nearby is the particular hammer he is looking for.

In addition to the displays shown in FIG. 3, many other types of indicators can form part of an indicator apparatuses, and are contemplated by the inventor. For example, the indicator apparatus can include a network of lights or displays 50 suspended from the ceiling of a store, as shown in FIG. 4. After the interface device 12, such as a computer kiosk, sends an activation signal to the network 50 via the communication apparatus (not shown in FIG. 3), a particular set of lights or displays 52 are activated that indicate to the user where the particular item is located. A laneway 54 can also be activated by turning on lights to indicate to the purchaser one possible path to take to reach the item to be purchased. Advantageously, the purchaser sees the activated lights or displays 54 from the location of the interface device 12 and therefore knows in which direction to walk to reach the particular item. Alternatively, the laneway of lights can be disposed on the floor.

As mentioned previously, and referring to FIG. 5, another type of indicator apparatus 70 includes a display 72 of a cell phone 74. The interface device can be a computer kiosk 76. The kiosk can be located in the store, or outside the store. For example, the kiosk 76 can be located outside the store in a mall where the store is located. The interface device can send an activation signal via a communication line 78 to a communication apparatus 80 that includes a transmitter 82.

The transmitter 82 sends a wireless, electromagnetic signal to a receiver 84 of the cell phone 74 of the user that causes the display 72 of the cell phone 74 to indicate the location of the particular item. For example, the display 72 might read, “the claw hammer is located half way down aisle three, on the top shelf.” Alternatively, the display can provide graphical information that indicates the location of the particular item. For example, the display can show a store plan containing aisles, or other landmarks in the store, and a flashing beacon to indicate the location of the particular item among the aisles. Of course, in such embodiments the information provided on the phone's display might have also been provided on the kiosk display. But according to the principles of the present invention, the customer can have a copy of the information on his phone for him to carry around the store. This may be particularly helpful when there is a lot of information provided about one or more items in the store.

To further guide the user/purchaser, the cell phone can provide audible messages to direct the user to the particular item. Thus, the cell phone might convey the following message: “walk northwards until you reach the second aisle,” and then just before reaching the second aisle “turn east at the next aisle.” Four large, easily-seen banners on which are written “north,” “south,” “east,” and “west” can be placed in conspicuous locations in the store to help purchasers determine which way is north, south, east and west. Instead of the four geographic directions, colors, numbers or other markers can be used. Thus, the cell phone might relay “at the next aisle, turns toward the red banner.” Any navigation system known to those in the art that can track the position of a cell phone and direct the user to a specified location where the item to be purchased is located may be used.

The indicator apparatus can emit visual or audible cues. Thus, in the last example, in addition to voice instruction, a sound can be emitted from the cell phone that gets louder the closer the cell phone is to the location where the item is normally stored.

Instead or in addition to the computer kiosk 76 of FIG. 5, the interface device can include a portion of the cell phone 74 that could include the keypad 86 of the phone 74. Alternatively, instead of using the keypad, voice commands can be given using the phone 74 if voice recognition software is employed. A customer can dial a phone number, and then, in response to prompts, use the cell phone to enter information about a particular item, such as the hammer mentioned above. For example, the prompts might ask the customer to enter the location of a particular store. Then, the customer may be prompted to enter the item he is looking for. The prompts may provide multiple-choice options to zero in on the item. For example, “If you wish to purchase a television, press 1, if you wish to purchase a tool, press 2, if you wish to purchase a kitchen appliance, press 3, etc.

In such manner, by utilizing an interface device connected to an indicator apparatus via a communication apparatus, an indicator can be activated to emit a signal indicative of the location of the particular item. This system aids the customer in finding the item.

In operation, a user enters information using the interface device 12. The user can enter information via a keyboard or keypad and can optionally view information on the display 16 of the interface device 12. The user inputs information that allows the identification of the particular item that the user wishes to purchase from the store. After the user enters commands associated with the particular item, the interface device 12 sends activation signals to the indicator apparatus 18 via the communication apparatus 22. These signals cause the indicator corresponding to the particular item to be activated. The corresponding indicator may be proximal to the particular item and produces a detectable signal that is indicative of the location of the particular item within the store.

FIG. 6 is a flow chart 100 of a method for purchasing a particular item located within a store. In step 102, information about the particular item is received using an interface device 12. The interface device can include a cell phone with a keypad, or a computer kiosk with a touch screen display to enter information. In step 104, a signal is transmitted via a communication apparatus 22, such as a local area network (LAN), from the interface device 12 to an indicator apparatus 18 having at least one indicator. There are one or more indicators corresponding to each item in a collection of items in the store. In step 106, the one or more indicators corresponding to the particular item emit a signal indicative of the location thereof. As described above, the one or more indicators can include the display of a cell phone, lights on the floor or ceiling of the store, or a display near the item that displays a message that is indicative of the location of the item.

The embodiments described herein are exemplary. Many other embodiments also fall within the scope of the invention, which scope is provided by the ensuing claims.

What is claimed is:

1. A system for purchasing a particular item located within a store, the system comprising:
an interface device having an input device;
an indicator apparatus having at least one indicator, one or more indicators corresponding to each item in a collection of items in the store; and
a communication apparatus for communication between the interface device and the indicator apparatus, wherein the input device accepts data associated with the particular item and causes the one or more indicators corresponding thereto to emit a signal indicative of the location of the particular item.

2. The system of claim 1, wherein the interface device includes at least one of a kiosk, a personal computer and a phone.

3. The system of claim 1, wherein the interface device includes at least one of a keyboard, a keypad and a display.

4. The system of claim 1, wherein the one or more indicators are proximal to the item to which the one or more indicators correspond.

5. The system of claim 1, wherein the indicator apparatus includes a cell phone.

6. The system of claim 1, wherein the at least one indicator includes at least one display in communication with the interface device via the communication apparatus.

7. The system of claim 6, wherein the signal is a message shown on at least one of the at least one display.

8. The system of claim 1, wherein the indicator apparatus includes a cell phone and the signal is seen or heard on the cell phone.

9. The system of claim 1, wherein the indicator apparatus includes a network of lights suspended from a ceiling of the store.

10. The system of claim 1, wherein the indicator apparatus includes a series of lights, which when activated, defines a pathway leading to the particular item.

11. A method of purchasing a particular item located within a store, the method comprising:
receiving information about the particular item using an interface device;
transmitting via a communication apparatus a signal from the interface device to an indicator apparatus having at least one indicator, one or more indicators corresponding to each item in a collection of items in the store; and
emitting a signal indicative of the location of the particular item using the one or more indicators corresponding thereto.

12. The method of claim 11, wherein, in the step of receiving, the interface device includes at least one of a kiosk, a personal computer and a phone.

13. The method of claim 1 wherein, in the step of receiving, the interface device includes at least one of a keyboard, a keypad and a display.

14. The method of claim 11, wherein, in the step of transmitting, the one or more indicators are proximal to the item to which the one or more indicators correspond.

15. The method of claim 11, wherein, in the step of transmitting, the at least one indicator includes a display of a cell phone.

16. The method of claim 11, wherein, in the step of transmitting, the at least one indicator includes a network of lights suspended from a ceiling of the store.

17. The method of claim 11, wherein the one or more indicators includes a display near the particular item, wherein the step of emitting includes displaying a message on the display to help locate the particular item.
